(19) United States
(12) Patent Application Publication
(10) Pub. No.: US 2008/0317476 A1
(43) Pub. Date: Dec. 25, 2008

(54) Vehicle-Mounted Optical Communication System and Vehicle-Mounted Optical Transmitter

(75) Inventors: Masayoshi Tsuji, Tokyo (JP); Hiroshi Hatakeyama, Tokyo (JP); Kimiyoshi Fukatsu, Tokyo (JP); Takayoshi Anan, Tokyo (JP); Naofumi Suzuki, Tokyo (JP); Kenichiro Yashiki, Tokyo (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 12/279,509

(22) PCT Filed: Dec. 28, 2006
(86) PCT No.: PCT/JP2006/326201

§ 371 Date: Aug. 14, 2008

(30) Foreign Application Priority Data
Feb. 24, 2006 (JP) 2006-049236

(51) Int. Cl. H04B 10/00

(52) U.S. Cl. 398/140

(57) ABSTRACT

A vehicle-mounted optical communication system, which uses an optical signal to perform data transmission, comprises a first optical transmitter and an optical receiver. The first optical transmitter, which is mounted on a vehicle, has a multiple quantum well structure, in which an active layer has a quantum well layer of InₓGa₁₋ₓAs (where 0.15≦x≦0.35), and includes a first surface emitting laser the oscillation wavelength of which is between 1000 nm and 1100 nm inclusive. The first optical transmitter transmits an optical signal generated by the first surface emitting laser. The optical receiver, which is mounted on the vehicle and connected to the first optical transmitter via a first optical transmission path, receives the optical signal, which was transmitted by the first optical transmitter, via the first optical transmission path.

### TECHNICAL FIELD

The present invention relates to a vehicle-mounted optical communication system and an optical transmitter therefor.

### BACKGROUND ART

Heretofore, many vehicles have incorporated various devices including audio devices, navigation systems, and cameras for capturing images outside of the vehicle. When such many devices are incorporated in a vehicle, the vehicle has a vehicle-mounted optical communication system interconnecting the devices with optical transmission paths. In the vehicle-mounted optical communication system, electric signals to be transmitted are converted by light source devices having LEDs or the like into optical signals to pass through the optical transmission paths.

The transmission rate on the vehicle-mounted optical communication system is in the range from about 25 to 50 Mbps at present. However, as there are demands for transmission rate increases, the transmission rate is considered to approach 1 Gbps in the future.

To meet such demands for increased transmission rates, efforts to use surface-emitting lasers instead of LEDs are being made on research and development levels (see JP-A No. 2005-26770).

### DISCLOSURE OF THE INVENTION

Vehicle-mounted optical communication systems installed in vehicles are used in severe environments. Specifically, the vehicle-mounted optical communication systems are required to be durable in environments at temperatures as high as about 125° C. However, surface-emitting lasers having an oscillation wavelength band of 850 nm which have heretofore been used in vehicle-mounted optical communication systems are of poor durability in environments at temperatures as high as about 125° C.

Consequently, it has been difficult to increase the reliability of vehicle-mounted optical communication systems which incorporate surface-emitting lasers having an oscillation wavelength band of 850 nm.

It is an object of the present invention to provide a vehicle-mounted optical communication system which is highly reliable.

To achieve the above object, a vehicle-mounted optical communication system according to the present invention, adapted to be mounted on a vehicle, for performing data transmission with optical signals, comprises a first optical transmitter and an optical receiver.

The first optical transmitter includes a first surface-emitting laser having an active layer of a multiple quantum well structure having a quantum well layer of InₓGa₁₋ₓAs (0.15≦x≦0.35), the first surface-emitting laser having an oscillation wavelength ranging from 1000 nm to 1100 nm inclusive.

The first optical transmitter and the optical receiver are adapted to be mounted on the vehicle and are connected to each other by a first optical transfer path. The first optical transmitter transmits an optical signal generated by the first surface-emitting laser. The optical receiver receives the optical signal transmitted from the first optical transmitter through the first optical transfer path.

### BRIEF DESCRIPTION OF THE DRAWINGS

FIG. 1 is a diagram showing the relationship between the oscillation wavelengths of surface-emitting lasers and the reliability thereof;

FIG. 2 is a diagram showing a vehicle-mounted optical communication system according to a first exemplary embodiment of the present invention;

FIG. 3 is a cross-sectional view of a surface-emitting laser;

FIG. 4 is a perspective view of a package;

FIG. 5 is a graph showing the temperature dependency of a modulating operation of a surface-emitting laser incorporated in the vehicle-mounted optical communication system according to the first exemplary embodiment;

FIG. 6 is a diagram showing a vehicle-mounted optical communication system according to a second exemplary embodiment of the present invention;

FIG. 7 is a view of a photodetector of the vehicle-mounted optical communication system according to the second exemplary embodiment;

FIG. 8 is a view of a surface-emitting laser incorporated in the vehicle-mounted optical communication system according to the second exemplary embodiment;

FIG. 9 is a diagram showing a vehicle-mounted optical communication system according to a third exemplary embodiment of the present invention; and

FIG. 10 is a view of a photodetector of the vehicle-mounted optical communication system according to the third exemplary embodiment.

### BEST MODE FOR CARRYING OUT THE INVENTION

Exemplary embodiments of the present invention will be described in detail below with reference to the drawings.

The inventors of the present invention have considered that the durability of a surface-emitting laser in severe environments is lowered by the growth of crystalline defects in an active layer due to a temperature rise.

The inventors have considered that it is important to suppress the growth of crystalline defects in the active layer of the surface-emitting laser in order to provide a vehicle-mounted optical communication system which is highly reliable in severe environments.

It has been realized that crystalline defects are easy to grow in surface-emitting lasers having an oscillation wavelength band of 850 nm according to the background art because the active layer thereof generally comprises a quantum well layer of GaAs and a barrier layer of AlGaAs. In particular, if the environmental temperature rises or the current density rises, then crystalline defects grow significantly, and the service life of surface-emitting lasers decreases significantly.

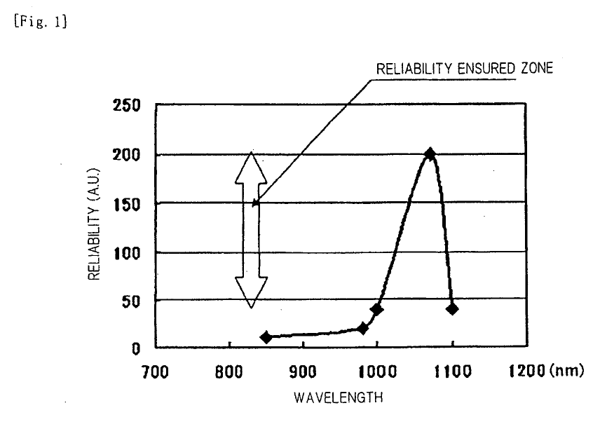

The inventors have studied the relationship between the growth of crystalline defects and the oscillation wavelength (the proportion of In in an InₓGa₁₋ₓAs layer as a quantum well layer), and reached the conclusion shown in FIG. 1.

The inventors have found that as shown in FIG. 1, the reliability of a surface-emitting laser is greatly improved by increasing the proportion of In into the range of 0.15≦x≦0.35 and keeping the oscillation wavelength in the range from 1000 nm to 1100 nm inclusive. FIG. 1 shows simulated times required until the intensity of light drops 20% when a current of given value passes through surface-emitting lasers having respective proportions of in (oscillation wavelengths). The reliability represented by the vertical axis shows relative values of the times required until the intensity of light drops 20%. In FIG. 1, the values of reliability represented by the vertical axis are required to be 48 or greater. The proportion of In in the quantum well layer of the surface-emitting layer having an oscillation wavelength band of 850 nm is nil.

In an oscillation wavelength range from 1000 nm to 1100 nm inclusive, the added In is considered to pin and reduce the growth of crystalline defects. In addition, the high differential gain of InGaAs itself is considered to greatly reduce the amount of drive current for the surface-emitting laser, thereby preventing the temperature in the active layer of the surface-emitting laser from rising for greatly increased reliability.

FIG. 1 is plotted when the environmental temperature is 100° C. and the transmission rate is 1 Gbps. It is known that the same results are obtained when the environmental temperature is 125° C.

Vehicle-mounted optical communication systems according to exemplary embodiments of the present invention comprise an optical transmitter having a light source device, a transfer medium for transferring light from the optical transmitter, and an optical receiver for receiving the light transferred by the transfer medium. The vehicle-mounted optical communication systems serve to transfer data at a high rate of 1 Gbps or higher. The light source device comprises a surface-emitting layer having a GaAs substrate and an active layer disposed on the GaAs substrate. The active layer is of a multiple quantum well structure having a quantum well layer of InₓGa₁₋ₓAs (0.15≦x≦0.35), and the surface-emitting laser has an oscillation wavelength ranging from 1000 nm to 1100 nm inclusive.

With the above arrangement, the active layer of the surface-emitting laser has a quantum well layer of InₓGa₁₋ₓAs (0.15≦x≦0.35) and the surface-emitting laser has an oscillation wavelength ranging from 1000 nm to 1100 nm inclusive. The surface-emitting laser is highly reliable in severe temperature environments. The vehicle-mounted optical communication system which incorporates the surface-emitting laser is highly reliable.

There is known a surface-emitting laser with an active layer having a quantum well layer of In_{0.2}Ga_{0.8}As as disclosed in JP-A No. 10-233559. However, it has heretofore not been known at all to increase durability against environmental temperatures for high reliability in severe temperature environments by keeping the proportion of In in a quantum well layer of InₓGa₁₋ₓAs in the range of 0.15≦x≦0.35 and keeping the oscillation wavelength in the range from 1000 nm to 1100 nm inclusive. In other words, it has heretofore not been anticipated to be able to provide a highly reliable vehicle-mounted optical communication system by incorporating therein a surface-emitting laser having a quantum well layer of InₓGa₁₋ₓAs (0.15≦x≦0.35) and an oscillation wavelength ranging from 1000 nm to 1100 nm inclusive.

Exemplary embodiments of the present invention will be described in detail below with reference to the drawings. Similar components are denoted by similar reference characters throughout views and will not be described below.

### 1st Exemplary Embodiment

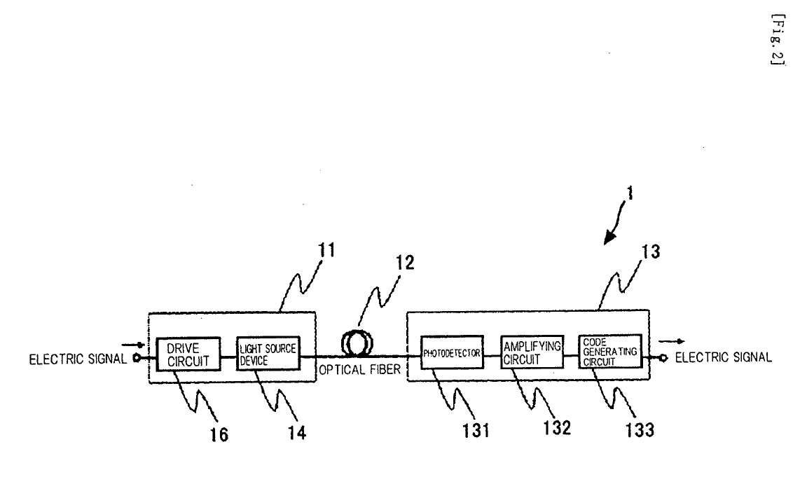

FIG. 2 shows vehicle-mounted optical communication system 1 according to the present invention.

Vehicle-mounted optical communication system 1 comprises optical transmitter 11 having light source device 14, transfer medium 12 for transferring light from optical transmitter 11, and optical receiver 13 for receiving the light transferred by transfer medium 12. The vehicle-mounted optical communication system serves to transfer data at a high rate of 1 Gbps or higher.

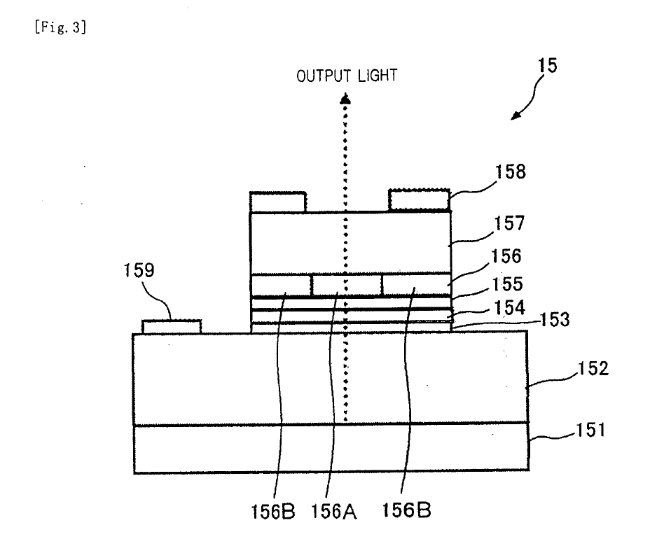

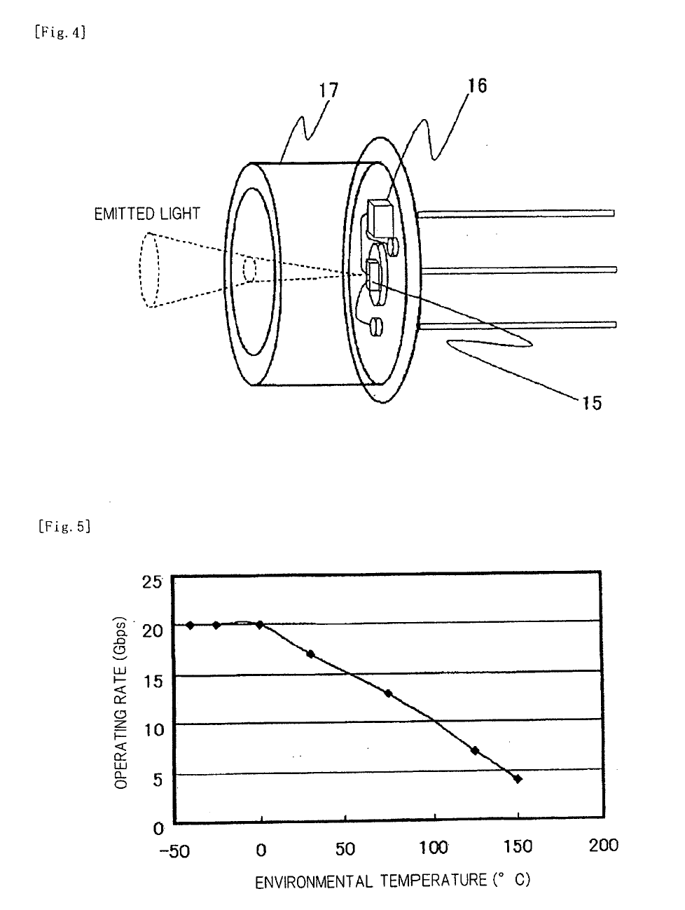

As shown in FIG. 3, light source device 14 comprises surface-emitting laser 15 including GaAs substrate 151 and active layer 154 disposed on GaAs substrate 151. Active layer 154 is of a multiple quantum well structure having a quantum well layer of InₓGa₁₋ₓAs (0.15≦x≦0.35). Surface-emitting laser 15 has an oscillation wavelength ranging from 1000 nm to 1100 nm inclusive.

Details of vehicle-mounted optical communication system 1 will be descried in detail below.

Optical transmitter 11 is incorporated in a camera for capturing images outside of the vehicle. An electric signal based on an image captured by the camera is supplied to optical transmitter 11.

Optical transmitter 11 comprises light source device 14 and drive circuit 16 for energizing light source device 14. Drive circuit 16 is supplied with an electric signal based on an image captured by the camera, and modulates light emitted by surface-emitting laser 15 of light source device 14 with the electric signal.

As shown in FIG. 3, surface-emitting laser 15 comprises GaAs substrate 151 as a semiconductor substrate, first DBR (Distributed Bragg Reflector) layer 152 disposed on GaAs substrate 151, cladding layer 153 disposed on first DBR layer 152, active layer 154 disposed on cladding layer 153, second cladding layer 155 disposed on active layer 154, current constricting layer 156 disposed on second cladding layer 155, and second DBR (Distributed Bragg Reflector) layer 157 disposed on current constricting layer 156.

Surface-emitting laser 15 is of the vertical resonator type.

First DBR layer 152 is an n-type semiconductor multilayer film comprising an alternate stack of n-type AlGaAs films and n-type GaAs films.

Cladding layer 153 comprises a GaAs layer, for example.

Active layer 154 is an MQW (Multiple Quantum Well) layer comprising an alternate stack of quantum well layers of InₓGa₁₋ₓAs (0.15≦x≦0.35) and GaAs barrier layers. In the present exemplary embodiment, the quantum well layers comprise an In_{0.25}Ga_{0.75}As layer, and surface-emitting laser 15 has an oscillation wavelength of 1070 nm.

Second cladding layer 155 comprises a GaAs layer, for example.

Current constricting layer 156 comprises an AlAs layer. Current constricting layer 156 includes low-resistance region 156A. Low-resistance region 156A is sandwiched between high-resistance regions (oxide regions) 156B having a higher resistance value than low-resistance region 156A and formed by a steam oxidation process.

Second DBR layer 157 is a p-type semiconductor multilayer film comprising an alternate stack of p-type AlGaAs films and p-type GaAs films.

Upper electrode 158 is disposed on second DBR layer 157, and lower electrode 159 is disposed on first DBR layer 152.

Surface-emitting laser 15 is produced by successively growing layers 152 through 157 on GaAs substrate 151 by MOVPE (Metal-Organic Vapor Phase Epitaxy), gas source MBE (Molecular Beam Epitaxy), or the like.

Surface-emitting laser 15 of light source device 14 and drive circuit 16 are sealed in package 17 as shown in FIG. 14. Package 17 is made of plastics or metal and is of a hollow cylindrical shape. Surface-emitting laser 15 and drive circuit 16 are fixedly mounted on the bottom surface of package 17. Package 17 is filled with an electrically insulative liquid or gel (e.g., silicone-base liquid or gel).

Vehicle-mounted optical communication system 1 will be described below with reference to FIG. 2 again.

Transfer medium 12 serves to transfer an optical signal from surface-emitting laser 15 of light source device 14, and comprises, for example, an optical fiber such as a polymer-clad optical fiber (PCF) or the like.

Optical receiver 13 serves to receive the optical signal from transfer medium 12, and comprises photodetector 131, amplifying circuit 132, and code generating circuit 133.

Photodetector 131 may be any photodetector insofar as it can detect light in a wavelength range from 1000 nm to 1100 nm, emitted from surface-emitting laser 15.

Photodetector 131 converts the optical signal into an electric signal, which is decoded as it is processed by amplifying circuit 132 and code generating circuit 133.

Optical receiver 13 is incorporated in a monitor or the like installed in the vehicle, for example. The electric signal decoded by optical receiver 13 is transmitted to the monitor or the like installed in the vehicle.

When the transfer medium 12 of vehicle-mounted optical communication system 1 was in the form of a polymer-clad optical fiber (PCF) having a length of 10 m, the transmission rate was 1 Gbps at an environmental temperature ranging from −40° C. to 125° C. At an environmental temperature of 100° C., vehicle-mounted optical communication system 1 was reliable for 5000 hours (it took 5000 hours before the intensity of light dropped 20%).

An experiment was conducted about the temperature dependency of a modulating operation of surface-emitting laser 15 incorporated in vehicle-mounted optical communication system 1.

The results are shown in FIG. 5. It can be confirmed that surface-emitting laser 15 could operate at a high rate of 4 Gbps at a high temperature of 150° C.

According to the present exemplary embodiment, active layer 154 of surface-emitting laser 15 includes a quantum well layer of InₓGa₁₋ₓAs (0.15≦x≦0.35), and surface-emitting laser 15 has an oscillation wavelength ranging from 1000 nm to 1100 nm inclusive. Surface-emitting laser 15 thus constructed is highly reliable in severe temperature environments. Vehicle-mounted optical communication system 1 which incorporates surface-emitting laser 15 is thus highly reliable.

According to the present exemplary embodiment, surface-emitting laser 15 and drive circuit 16 are accommodated in package 17, and package 17 is with an electrically insulative liquid or gel. The liquid or gel in package 17 is capable of absorbing vibrations in the vehicle.

According to the present exemplary embodiment, the liquid or gel in package 17 comprises a silicone-base liquid or gel. Since the silicone-base liquid or gel is of excellent thermal conductivity, it can quickly dissipate the heat generated by active layer 154 of surface-emitting laser 15, thereby reliably preventing surface-emitting laser 15 from being deteriorated.

Inasmuch as the silicone-base liquid or gel has a refractive index greater than 1, the light emitted from surface-emitting laser 15 travels straight in package 17 without being spread, reducing any coupling loss between package 17 and the optical fiber of transfer medium 12. Specifically, the silicone-base liquid or gel in package 17 reduces the coupling loss from 2 dB, which occurs if package 17 is dispensed with, to 1 dB.

### 2nd Exemplary Embodiment

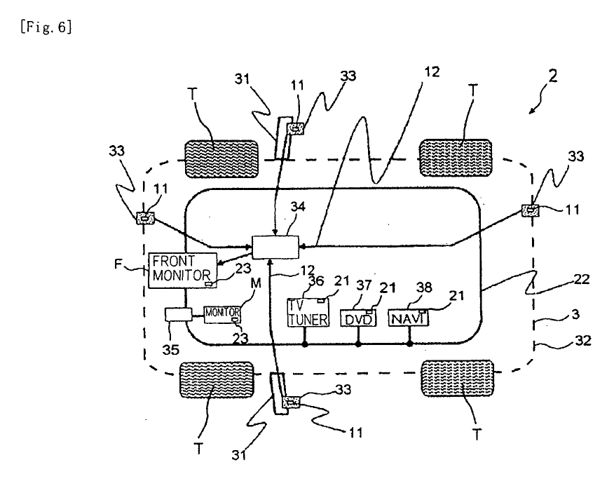

A second exemplary embodiment of the present invention will be described below with reference to FIG. 6.

Vehicle-mounted optical communication system 2 according to the present exemplary embodiment comprises optical transmitter 11 having light source device 14 similar to the light source device according to the preceding exemplary embodiment, transfer medium 12 for transferring light from optical transmitter 11, and optical receiver 23 for receiving the light transferred by transfer medium 12. Vehicle-mounted optical communication system 2 also includes second optical transmitter 21 having a second light source and second transfer medium 22 for transferring light from second optical transmitter 21.

Vehicle-mounted optical communication system 2 performs data communications at a high rate of 1 Gbps or higher.

Optical transmitter 11 is fixedly mounted in side mirrors 31 of vehicle 3 and cameras 33 attached to front and rear portions of vehicle body 32 of vehicle 3. The reference characters T in FIG. 6 represent tires of vehicle 3.

Transfer medium 12 connects optical transmitters 11 in cameras 33 to switching controller 34, and also connects switching controller 34 to front monitor F.

Switching controller 34 selects connections between front monitor F and optical transmitters 11 in cameras 33. Switching controller 34 comprises an optical switch, for example.

Optical receiver 23 is incorporated in front monitor F. Optical receiver 23 converts an optical signal into an electric signal to display images captured by cameras 33 on front monitor F. In the present exemplary embodiment, front monitor F and switching controller 34 are shown as being separate from each other. However, front monitor F and switching controller 34 may be integral with each other.

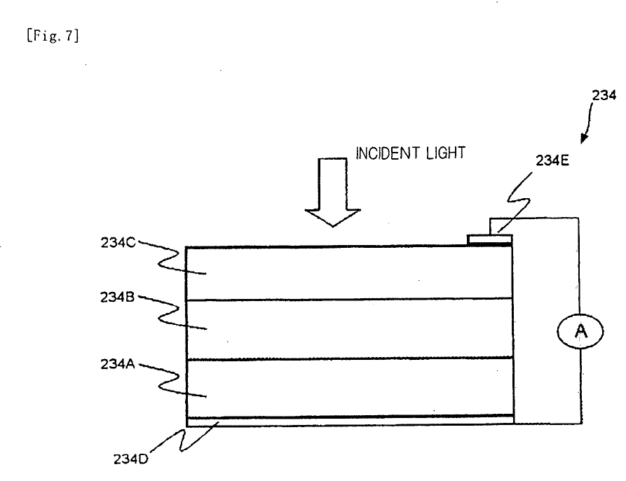

According to the present exemplary embodiment, optical receiver 23 includes photodetector 234 shown in FIG. 7 rather than photodetector 131 according to the preceding exemplary embodiment. Optical receiver 23 is of the same structure as optical receiver 13 according to the preceding exemplary embodiment with respect to other details.

Photodetector 234 is capable of detecting light having a wavelength band of 850 nm and light having a wavelength in the range from 1000 to 1100 nm.

Photodetector 234 comprises n-type InP substrate 234A as a semiconductor substrate, optical absorption layer 234B disposed on InP substrate 234A, and cap layer 234C disposed on optical absorption layer 234B.

A buffer layer, a multiplier layer, an electric field relaxing layer, etc. may be interposed between optical absorption layer 234B and InP substrate 234A.

Optical absorption layer 234B comprises an InGaAs layer lattice-matched to InP substrate 234A.

Cap layer 234C is made of a semiconductor material having a forbidden bandwidth of 1.46 eV or greater, e.g., InAlAs. n-type electrode 234D is disposed on cap layer 234C.

n-type electrode 234D is disposed on the reverse surface of in P substrate 234A.

Second optical transmitter 21 serves to transmit an optical signal in the 850 nm band. According to the present exemplary embodiment, second optical transmitter 21 is incorporated in various devices including TV tuner 36, DVD device 37, and navigation device 38.

Though not shown, second optical transmitter 21 comprises a drive circuit for receiving an electric signal generated by devices 36, 37, 38 and a second light source device energized by the drive circuit.

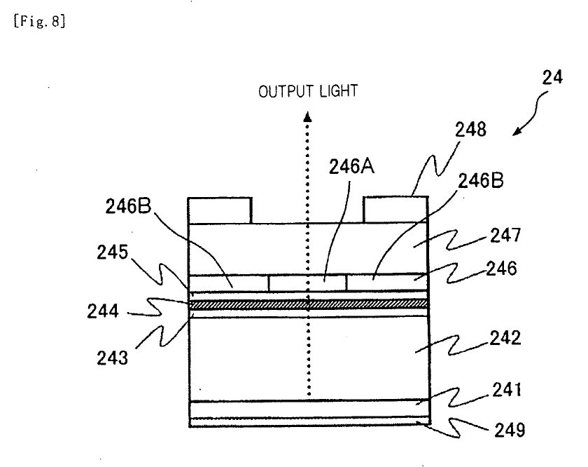

The second light source device comprises surface-emitting laser 24 shown in FIG. 8.

Surface-emitting laser 24 comprises GaAs substrate 241 as a semiconductor substrate, first DBR (Distributed Bragg Reflector) layer 242 disposed on GaAs substrate 241, lower cladding layer 243 disposed on first DBR layer 242, active layer 244 disposed on lower cladding layer 243, upper cladding layer 245 disposed on active layer 244, current constricting layer 246 disposed on upper cladding layer 245, and second DBR (Distributed Bragg Reflector) layer 247 disposed on current constricting layer 246.

First DBR layer 242 is an n-type semiconductor multilayer film comprising an alternate stack of Al0.1Ga0.9As and Al0.9Ga0.1As films.

Lower cladding layer 243 comprises an AlGaAs layer, for example.

Active layer 244 is an MQW (Multiple Quantum Well) layer comprising an alternate stack of quantum well layers of GaAs and AlGaAs barrier layers.

Upper cladding layer 245 comprises an AlGaAs layer, for example.

Current constricting layer 246 comprises an AlAs layer. Current constricting layer 246 includes low-resistance region 246A. Low-resistance region 246A is sandwiched between high-resistance regions (oxide regions) 246B having a higher resistance value than low-resistance region 246A and formed by a steam oxidation process.

Second DBR layer 247 is a p-type semiconductor multilayer film comprising an alternate stack of Al_{0.1}Ga_{0.9}As and Al_{0.9}Ga_{0.1}As films.

p-type electrode 248 is disposed on second DBR layer 247, and n-type electrode 249 is disposed on the reverse side of GaAs substrate 241.

Surface-emitting laser 24 has an oscillation wavelength band of 850 nm. Though not shown, surface-emitting laser 24 is housed in a package filled with an electrically insulative liquid or gel, as with surface-emitting laser 15.

Vehicle-mounted optical communication system 2 will be described below with reference to FIG. 6 again.

Second transfer medium 22 comprises a ring-shaped optical fiber and a linear optical fiber connected to the ring-shaped optical fiber. To second transfer medium 22, there are connected TV tuner 36, DVD device 37, navigation device 38, as described above, and also monitor M, front monitor F, and second switching controller 35.

Second switching controller 35 selects connections between second optical transmitter 21 in the TV tuner, the DVD device, and the navigation device, and monitor M or front monitor F. Second switching controller 35 may comprise an optical switch.

Optical receiver 23 is also disposed in monitor M.

When camera 33 captures an image, it generates an electric signal based on the captured image and sends the electric signal to optical transmitter 11 disposed in camera 33. In optical transmitter 11, drive circuit 16 receives the electric signal and energizes surface-emitting laser 15, Light emitted by surface-emitting laser 15 at a wavelength ranging from 1000 to 1100 nm is sent through transfer medium 12 to switching controller 34. The light is sent through switching controller 34 to front monitor F. In front monitor F, photodetector 236 of optical receiver 23 receives the optical signal and converts it into an electric signal. The converted electric signal is decoded as it is processed by amplifying circuit 132 and code generating circuit 133. In this manner, the image is displayed on front monitor F.

When TV tuner 36 receives a digital satellite broadcast or the like, or DVD device 37 or navigation device 38 acquires an image, TV tuner 36, DVD device 37 or navigation device 38 generates electric signals such as a video signal, an audio signal, etc. These electric signals are sent to the drive circuit of second optical transmitter 21, which energizes surface-emitting laser 24. Surface-emitting laser 24 emits light at a wavelength band of 850 nm, and the optical signal is sent through second transfer medium 22 to second switching controller 35. Second switching controller 35 determines a destination to which the optical signal is to be transmitted, and the optical signal is transmitted to monitor M or front monitor F.

In monitor M or front monitor F, photodetector 234 receives the optical signal and converts the optical signal into an electric signal. The converted electric signal is decoded as it is processed by amplifying circuit 132 and code generating circuit 133. In this manner, the image is displayed on front monitor F or monitor M.

It was confirmed that vehicle-mounted optical communication system 2 according to the present exemplary embodiment had a transmission rate of 1 Gbps at an environmental temperature ranging from −40° C. to 125° C.

Vehicle-mounted optical communication system 2 was reliable for 5000 hours at the environmental operating temperature of 100° C. of surface-emitting laser 15 (at this time, the environmental temperature of surface-emitting laser 24 was 50° C.).

Vehicle-mounted optical communication system 2 has the same advantages as with the first exemplary embodiment, and also offers the following advantages:

Information transmitted in the vehicle includes information, whose promptness is important, with respect to the safety of the user in the vehicle and information, whose promptness is less important, for use in entertainment. If these types of information are transmitted in the same wavelength band, then, depending on the amount of information, the transfer of the information with respect to the safety of the user may be delayed.

According to the present exemplary embodiment, the information with respect to the safety of the user is converted by surface-emitting laser 15 into an optical signal at a wavelength ranging from 1000 nm to 1100 nm, and the information for use in entertainment is converted by surface-emitting laser 14 into an optical signal at a wavelength band of 850 nm.

Since different wavelength bands are used depending on the promptness of information, the transfer of the information with respect to the safety of the user is prevented from being delayed.

According to the present exemplary embodiment, furthermore, photodetector 234 incorporated in front monitor F is capable of detecting both light at a wavelength band of 850 nm and light at a wavelength ranging from 1000 nm to 1100 nm. Therefore, the space required to install the photodetector is smaller than if photodetectors for detecting respective lights at those wavelengths are installed in front monitor F.

### 3rd Exemplary Embodiment

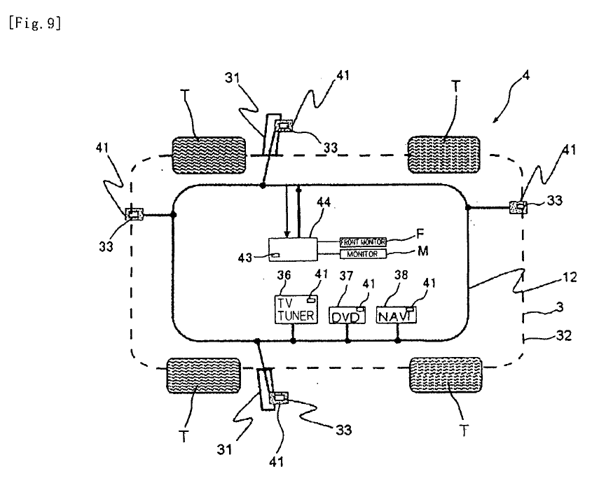

A third exemplary embodiment of the present invention will be described below with reference to FIG. 9.

Vehicle-mounted optical communication system 4 according to the present exemplary embodiment comprises optical transmitter 41 having surface-emitting laser 15 and surface-emitting laser 24 similar to those according to the second exemplary embodiment, transfer medium 12 for transferring light from optical transmitter 41, and optical receiver 43 for receiving the light transferred by transfer medium 12.

Optical transmitter 41 has a drive circuit similar to those according to the previous exemplary embodiments. The drive circuit serves to energize surface-emitting laser 15 and surface-emitting laser 24. These surface-emitting lasers 15, 24 are accommodated in a package filled with an electrically insulative liquid or gel as with the above exemplary embodiments.

Optical transmitter 41 is mounted in cameras 33, TV tuner 36, DVD device 37, and navigation device 38. In each of the devices including the cameras, acquired image data are divided by a data divider, not shown, and the divided data are converted into packets with various ancillary information (data name, source and destination addresses, transmission time, etc.) added as a transmission header to each of the data. The packetized data are send as an electric signal to the drive circuit of optical transmitter 41. The drive circuit energizes surface-emitting laser 15 and surface-emitting laser 24. Surface-emitting laser 24 generates an optical signal corresponding to the transmission header, and surface-emitting laser 15 generates an optical signal corresponding to the data itself. The optical signal corresponding to the transmission header and the optical signal corresponding to the data itself are transferred in synchronism with each other. The optical signal corresponding to the data itself can be transferred at a rate ranging from 1 Gbps to 5 Gbps.

Transfer medium 12 comprises a ring-shaped optical fiber and a linear optical fiber connected to the ring-shaped optical fiber. To transfer medium 12, there are connected cameras 33, TV tuner 36, DVD device 37, navigation device 38, and controller 44.

Controller 44 serves to control destinations of optical signals from devices 33, 36, 37, 38, and determine which of monitor M and front monitor F optical signals from devices 33, 36, 37, 38 are to be transferred to.

Controller 44 includes optical receiver 43.

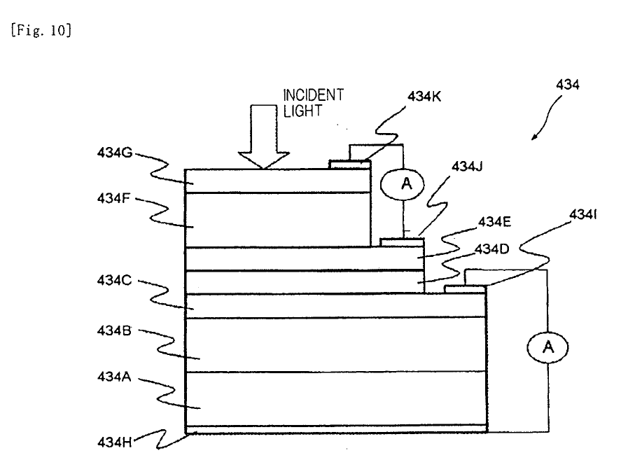

Optical receiver 43 comprises photodetector 434 shown in FIG. 10, and an amplifying circuit and a code generating circuit, not shown, similar to those according to the above exemplary embodiments.

Photodetector 434 comprises n-type InP substrate 434A as a semiconductor substrate, optical absorption layer 434B disposed on InP substrate 434A, cap layer 434C disposed on optical absorption layer 434B, insulating layer 434D disposed on cap layer 434C, n-type InP layer 434E as a semiconductor layer disposed on insulating layer 434D, optical absorption layer 434F disposed on InP layer 434E, and cap layer 434G disposed on optical absorption layer 434F.

n-type electrode 434H is disposed on the reverse surface of InP substrate 434A.

Optical absorption layer 434B comprises an InGaAs layer lattice-matched to InP substrate 434A.

Cap layer 434C is made of a semiconductor material having a forbidden bandwidth of 1.46 eV or greater, e.g., p-type InP.

Insulating layer 434D comprises an Ru-doped InP layer, for example.

Optical absorption layer 434F is made of a semiconductor material having a forbidden bandwidth greater than 1.15 eV, e.g., InAlGaAs.

Cap layer 434G is made of a semiconductor material having a forbidden bandwidth greater than 1.49 eV, e.g., p-type InAlAs. p-type electrode 434K is disposed on cap layer 434G.

Optical absorption layer 434B is disposed so as to fully cover substantially the entire surface of InP substrate 434A, and cap layer 434C is also disposed so as to fully cover substantially the entire surface of optical absorption layer 434B.

Insulating layer 434D and InP layer 434E are smaller in planar configuration than cap layer 434C, and n-type electrode 434I is disposed on an area of cap layer 434C which is not covered with insulating layer 434D and InP layer 434E.

Optical absorption layer 434F and cap layer 434G are smaller in planar is configuration than InP layer 434E, and n-type electrode 434J is disposed on an area of InP layer 434E which is not covered with optical absorption layer 434F and cap layer 434G.

With photodetector 434 thus constructed, optical absorption layer 434B is capable of absorbing light at a wavelength ranging from 1000 to 1100 nm, and optical absorption layer 434F is capable of absorbing light at a wavelength band of 850 nm.

An optical signal emitted from optical transmitter 41 includes an optical signal at a wavelength band of 850 nm which corresponds to a transmission header and an optical signal at a wavelength ranging from 1000 to 1100 nm which corresponds to data itself. Photodetector 434 can thus separately detect the optical signal at a wavelength band of 850 nm and the optical signal at a wavelength ranging from 1000 to 1100 nm. The separate optical signals are converted into respective electric signals, which are decoded as they are processed by the amplifying circuit and the code generating circuit.

Controller 44 analyzes the electric signal corresponding to the transmission header to determine which of monitor M and front monitor F the electric signal corresponding to the data itself is to be transferred to.

Front monitor F or monitor M displays an image based on the electric signal sent from controller 44.

The present exemplary embodiment has the same advantages as with the above exemplary embodiments, and also offers the following advantages:

According to the present exemplary embodiment, optical transmitter 41 generates an optical signal at a wavelength band of 850 nm which corresponds to a transmission header and an optical signal at a wavelength ranging from 1000 to 1100 nm which corresponds to data itself. Since the transmission header is of a low volume and can be transmitted at a low rate, surface-emitting laser 24 is less liable to be heated and is kept reliable.

The data itself is of a high volume and needs to be transmitted promptly. Since surface-emitting laser 15, which is of high heat resistance, for generating an optical signal at a wavelength ranging from 1000 to 1100 nm is used to transmit the data itself, vehicle-mounted optical communication system 4 is kept reliable.

According to the present exemplary embodiment, photodetector 434 comprises optical absorption layer 434F made of a semiconductor material having a forbidden bandwidth greater than 1.15 eV and optical absorption layer 434B comprising an InGaAs layer. Therefore, photodetector 434 can separately detect an optical signal at a wavelength band of 850 nm and an optical signal at a wavelength ranging from 1000 to 1100 nm. Consequently, single photodetector 434 can separate optical signals in a plurality of wavelength bands for decoding the optical signals individually.

The present invention is not limited to the above exemplary embodiments, but covers modifications, improvements, etc. insofar as they can achieve the object of the present invention.

For example, though surface-emitting lasers 15, 24 are accommodated in package 17 in the above exemplary embodiments, the present invention is not limited to such a structure. Surface-emitting lasers 15, 24 may not be accommodated in package 17. Not only surface-emitting lasers 15, 24 but also photodetectors 131, 234, 434 of optical receivers 13, 23, 43 may be accommodated in package 17 filled with an electrically insulative liquid or gel. The electrically insulative liquid or gel in package 17 reduces the coupling loss from 2 dB, which occurs if surface-emitting lasers 15, 24 and photodetectors 131, 234, 434 are not housed in package 17, to 1 dB.

In the second exemplary embodiment, photodetector 234 including single optical absorption layer 234B for detecting an optical signal at a wavelength band of 850 nm and an optical signal at a wavelength ranging from 1000 to 1100 nm is employed. However, photodetector 434 according to the third exemplary embodiment may be employed.

In the third exemplary embodiment, after controller 44 converts an optical signal into an electric signal, controller 44 sends the electric signal to monitor M or front monitor F. Alternatively, controller 44 may send an optical signal to monitor M or front monitor F.

Specifically, the controller separates an optical signal sent from optical transmitter 41 into an optical signal corresponding to a transmission header and an optical signal corresponding to data itself. The controller converts the optical signal corresponding to a transmission header into an electric signal with a photodetector. Thereafter, the controller sends the optical signal corresponding to data itself to the monitor or the front monitor based on the electric signal corresponding to a transmission header. Unlike the third exemplary embodiment, the controller may have only a photodetector for detecting an optical signal corresponding to a transmission header (an optical signal at a wavelength band of 850 nm). The monitor or the front monitor may have only a photodetector for detecting an optical signal corresponding to data itself (an optical signal at a wavelength in the range from 1000 to 1100 nm).

Since data can be sent as an optical signal between the controller and monitor M or between the controller and front monitor F, the transmission rate for data between the controller and monitor M or between the controller and front monitor F is increased.

In the second exemplary embodiment and the third exemplary embodiment, TV tuner 36, DVD device 37, and navigation device 38 incorporate optical transmitters. However, TV tuner 36, DVD device 37, and navigation device 38 incorporate optical receivers.

For example, the monitors may incorporate optical transmitters and TV tuner 36, DVD device 37, and navigation device 38 may incorporate optical receivers for allowing signals to be transferred bidirectionally.

1. A vehicle-mounted optical communication system, adapted to be mounted on a vehicle, for performing data transmission with optical signals, comprising:
a first optical transmitter adapted to be mounted on the vehicle and including a first surface-emitting laser, for transmitting an optical signal generated by said first surface-emitting laser, said first surface-emitting laser including an active layer of a multiple quantum well structure having a quantum well layer of InₓGa₁₋ₓAs (0.15≦x≦0.35), said first surface-emitting laser having an oscillation wavelength ranging from 1000 nm to 1100 nm inclusive; and
an optical receiver adapted to be mounted on the vehicle and connected to said first optical transmitter by a first optical transfer path, for receiving said optical signal transmitted from said first optical transmitter through said first optical transfer path.

2. A vehicle-mounted optical communication system according to claim 1, wherein said first optical transmitter further includes a second surface-emitting laser having an oscillation wavelength band of 850 nm, for transmitting an optical signal generated by said second surface-emitting laser.

3. A vehicle-mounted optical communication system according to claim 2, wherein said first surface-emitting laser generates an optical signal representing data itself and said second surface-emitting laser generates an optical signal representing a transmission header.

4. A vehicle-mounted optical communication system according to claim 1, further comprising:
a second optical transmitter including a second surface-emitting laser having an oscillation wavelength band of 850 nm, for transmitting an optical signal generated by said second surface-emitting laser;
wherein said optical receiver is connected to said second optical transmitter by a second optical transfer path, for receiving said optical signal transmitted from said second optical transmitter through said second optical transfer path.

5. A vehicle-mounted optical communication system according to claim 4, wherein said second optical transmitter is used to transmit information which is less prompt than information to be transmitted by said first optical transmitter.

6. A vehicle-mounted optical communication system according to claim 2, wherein said optical receiver includes a photodetector comprising an optical absorption layer which comprises an InGaAs layer disposed on a semiconductor substrate and a cap layer disposed on said optical absorption layer and having a forbidden bandwidth of 1.46 eV or greater, and said optical receiver receives both the optical signal generated by said first surface-emitting laser and the optical signal generated by said second surface-emitting laser.

7. A vehicle-mounted optical communication system according to claim 2, wherein said optical receiver includes a photodetector comprising a first optical absorption layer which comprises an InGaAs layer disposed on a semiconductor substrate, a first cap layer disposed on said optical absorption layer and having a forbidden bandwidth of 1.46 eV or greater, an insulating layer disposed on said cap layer, a semiconductor layer disposed on said insulating layer, a second optical absorption layer disposed on said semiconductor layer and having a forbidden bandwidth of 1.15 eV or greater, and a second cap layer disposed on said second optical absorption layer and having a forbidden bandwidth of 1.46 eV or greater, and said optical receiver receives both the optical signal generated by said first surface-emitting laser and the optical signal generated by said second surface-emitting laser.

8. A vehicle-mounted optical communication system according to claim 1, wherein at least said first surface-emitting laser is housed in a sealed package which is filled with an electrically insulative liquid or gel.

9. A vehicle-mounted optical transmitter for use in an optical communication system, adapted to be mounted on a vehicle, for performing data transmission with optical signals, comprising:
a first light source device including a first surface-emitting laser, for transmitting an optical signal generated by said first surface-emitting laser, said first surface-emitting laser including an active layer of a multiple quantum well structure having a quantum well layer of InₓGa₁₋ₓAs (0.15≦x≦0.35), said first surface-emitting laser having an oscillation wavelength ranging from 1000 nm to 1100 nm inclusive; and
a drive circuit for energizing said first surface-emitting laser of said first light source device based on an electric signal.

10. A vehicle-mounted optical transmitter according to claim 9, further comprising a second light source device including a second surface-emitting laser having an oscillation wavelength band of 850 nm, for transmitting an optical signal generated by said second surface-emitting laser.

11. A vehicle-mounted optical transmitter according to claim 10, wherein said first surface-emitting laser generates an optical signal representing data itself and said second surface-emitting laser generates an optical signal representing a transmission header.

12. A vehicle-mounted optical transmitter according to claim 9, wherein at least said first surface-emitting laser is housed in a sealed package which is filled with an electrically insulative liquid or gel.

13. A vehicle-mounted optical receiver for use in an optical communication system, adapted to be mounted on a vehicle, for performing data transmission with optical signals, comprising:
a photodetector for detecting both a first optical signal at a wavelength band of 850 nm and a second optical signal at a wavelength ranging from 1000 nm to 1100 inclusive and converting the first and second optical signals into electric signals, said photodetector including an optical absorption layer which comprises an InGaAs layer disposed on a semiconductor substrate and a cap layer disposed on said optical absorption layer and having a forbidden bandwidth of 1.46 eV or greater; and
an amplifying circuit for receiving said electric signals from said photodetector and amplifying the received electric signals.

14. A vehicle-mounted optical receiver for use in an optical communication system, adapted to be mounted on a vehicle, for performing data transmission with optical signals, comprising:
a photodetector for detecting both a first optical signal at a wavelength band of 850 nm and a second optical signal at a wavelength ranging from 1000 nm to 1100 inclusive and converting the first and second optical signals into electric signals, said photodetector including a first optical absorption layer which comprises an InGaAs layer disposed on a semiconductor substrate, a first cap layer disposed on said optical absorption layer and having a forbidden bandwidth of 1.46 eV or greater, an insulating layer disposed on said cap layer, a semiconductor layer disposed on said insulating layer, a second optical absorption layer disposed on said semiconductor layer and having a forbidden bandwidth of 1.15 eV or greater, and a second cap layer disposed on said second optical absorption layer and having a forbidden bandwidth of 1.46 eV or greater; and
an amplifying circuit for receiving said electric signals from said photodetector and amplifying the received electric signals.

15. A vehicle-mounted optical communication system according to claim 4, wherein said optical receiver includes a photodetector comprising an optical absorption layer which comprises an in GaAs layer disposed on a semiconductor substrate and a cap layer disposed on said optical absorption layer and having a forbidden bandwidth of 1.46 eV or greater, and said optical receiver receives both the optical signal generated by said first surface-emitting laser and the optical signal generated by said second surface-emitting laser.

16. A vehicle-mounted optical communication system according to claim 4, wherein said optical receiver includes a photodetector comprising a first optical absorption layer which comprises an InGaAs layer disposed on a semiconductor substrate, a first cap layer disposed on said optical absorption layer and having a forbidden bandwidth of 1.46 eV or greater, an insulating layer disposed on said cap layer, a semiconductor layer disposed on said insulating layer, a second optical absorption layer disposed on said semiconductor layer and having a forbidden bandwidth of 1.15 eV or greater, and a second cap layer disposed on said second optical absorption layer and having a forbidden bandwidth of 1.46 eV or greater, and said optical receiver receives both the optical signal generated by said first surface-emitting laser and the optical signal generated by said second surface-emitting laser.
